(19) United States
(12) Patent Application Publication
(10) Pub. No.: US 2017/0061445 A1
(43) Pub. Date: Mar. 2, 2017

(54) GENERATION OF PROOF EXPLANATION IN REGULATORY COMPLIANCE MANAGEMENT

(71) Applicant: Tata Consultancy Services Limited, Mumbai (IN)

(72) Inventors: Sagar SUNKLE, Pune (IN); Deepali D P KHOLKAR, Pune (IN); Vinay KULKARNI, Pune (IN)

(73) Assignee: Tata Consultancy Services Limited, Mumbai (IN)

(21) Appl. No.: 15/247,098

(22) Filed: Aug. 25, 2016

(30) Foreign Application Priority Data
Aug. 25, 2015 (IN) 3257/MUM/2015

(51) Int. Cl. G06Q 30/00; G06F 17/27; G06Q 10/06

(52) U.S. Cl. CPC G06Q 30/018; G06Q 10/067; G06F 17/2735; G06F 17/2705; G06F 17/2785

(57) ABSTRACT

This disclosure relates generally to regulatory compliance management, and more particularly to method and system for generation of proof explanation in regulatory compliance management. In one embodiment, the method for includes modeling an operations dictionary associated with business facts data of an enterprise, a regulations dictionary from regulatory rules data and a terminological dictionary having terminological variations of concepts and natural language statements associated with the regulatory rules data. A proof of one of a compliance and non-compliance in form of one of success rules and failure rules and corresponding facts is obtained from a compliance determination engine. The method includes systematically mapping words selected from the operations dictionary, the regulations dictionary and the terminological dictionary based at least on a concept associated with the proof to obtain the explanation of the proof in natural language.

### PRIORITY CLAIM

This U.S. patent application claims priority under 35 U.S.C. §119 to: India Application No. 3257/MUM/2015, filed on Aug. 25, 2015. The entire contents of the aforementioned application are incorporated herein by reference.

### TECHNICAL FIELD

This disclosure relates generally to regulatory compliance management, and more particularly to a method and system for explanation of proofs of regulatory compliance and/or non-compliance in natural language.

### BACKGROUND

Modern enterprises face an unprecedented regulatory regime. Regulatory compliance requirements increasingly derive from emerging industry standards, internal business or ethical guidelines, or from the need to avoid reputational risks; they also derive from transparency requirements and assurance of quality and control of governance, processes, methods, and IT or infrastructure.

Auditors increasingly expect consistent evidence/explanation of compliance whereas enterprise management expects an accurate and succinct assessment of (risks associated with) compliance. In addition, industry compliance reporting trends reveal that explanations of proofs of (non-)compliance are requested by auditors and are increasingly expected to include which regulations a given operational practice of enterprise is subject to and what parts of a regulation does the practice depart from and why. The latter functionality is especially relevant for shareholders since it forces an enterprise to give business reasons for (non-) compliance.

However, complying with regulations in a cost effective manner may be difficult as regulations and changes therein tend to impact enterprises operational practices substantially. This can be attributed to the fact that regulations and changes therein tend to impact enterprises' operational practices substantially. With regards the state of the practice in compliance, one of the most sought after features is the ability to prove and explain compliance and/or non-compliance.

### SUMMARY

Embodiments of the present disclosure present technological improvements as solutions to one or more of the above-mentioned technical problems recognized by the inventors in conventional systems. For example, in one embodiment, a a processor-implemented method for generating explanation of proofs associated with regulatory information is provided. The method includes modeling an operations dictionary by identifying a first set of discriminative words from business facts data of an enterprise. The first set of discriminative words is indicative of a plurality of concepts in the business facts data. Further, the method includes modeling a regulations dictionary by identifying a second set of discriminative words from a regulatory rules data. The regulatory rules data is associated with compliance rules of the enterprise. Furthermore, the method includes modelling a terminological dictionary comprising terminological variations of the plurality of concepts and natural language statements associated with the regulatory rules data. Moreover, the method includes obtaining a proof of one of a compliance and non-compliance in form of one of success rules and failure rules and corresponding facts from a compliance determination engine. Also, the method includes systematically mapping words selected from the operations dictionary, the regulations dictionary and the terminological dictionary based at least on a concept associated with the proof to obtain the explanation of the proof in natural language.

In another embodiment, a system for generating explanation of proofs associated with regulatory information is provided. The system includes one or more memories storing instructions; and one or more hardware processors coupled to said one or more memories. The one or more hardware processors configured by said instructions to model an operations dictionary by identifying a first set of discriminative words from business facts data of an enterprise. The first set of discriminative words is indicative of a plurality of concepts in the business facts data. Further, the one or more hardware processors configured by said instructions to model a regulations dictionary by identifying a second set of discriminative words from a regulatory rules data. The regulatory rules data is associated with compliance rules of the enterprise. Furthermore, the one or more hardware processors configured by said instructions to model a terminological dictionary comprising terminological variations of the plurality of concepts and natural language statements associated with the regulatory rules data. Moreover, the one or more hardware processors configured by said instructions includes to obtain a proof of one of a compliance and non-compliance in form of one of success rules and failure rules and corresponding facts from a compliance determination engine. Also, the one or more hardware processors configured by said instructions includes systematically map words selected from the operations dictionary, the regulations dictionary and the terminological dictionary based at least on a concept associated with the proof to obtain the explanation of the proof in natural language.

In yet another embodiment, a non-transitory computer-readable medium having embodied thereon a computer program for executing a method for generating explanation of proofs associated with regulatory information, is provided. The method includes modeling an operations dictionary by identifying a first set of discriminative words from business facts data of an enterprise. The first set of discriminative words is indicative of a plurality of concepts in the business facts data. Further, the method includes modeling a regulations dictionary by identifying a second set of discriminative words from a regulatory rules data. The regulatory rules data is associated with compliance rules of the enterprise. Furthermore, the method includes modelling a terminological dictionary comprising terminological variations of the plurality of concepts and natural language statements associated with the regulatory rules data. Moreover, the method includes obtaining a proof of one of a compliance and non-compliance in form of one of success rules and failure rules and corresponding facts from a compliance determination engine. Also, the method includes systematically mapping words selected from the operations dictionary, the regulations dictionary and the terminological dictionary based at least on a concept associated with the proof to obtain the explanation of the proof in natural language.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary a network implementation for generation of proof explanation in regulatory compliance management system according to some embodiments of the present disclosure.

FIG. 2 is a functional block diagram of a system for generation of proof explanation in regulatory compliance management according to some embodiments of the present disclosure.

FIGS. 3A and 3B illustrate procedure box abstractions for the generated formal proof trace of regulatory compliance management in accordance with some embodiments of the present disclosure.

FIG. 4 illustrates an example representation of building a vocabulary for natural language explanations pertaining to regulatory compliance proof generation according to some embodiments of the present disclosure.

FIG. 5 illustrates a flow diagram of a method for generation of proof explanation in regulatory compliance management according to some embodiments of the present disclosure.

FIG. 6A illustrates an example workflow for regulatory compliance management in a banking environment according to some embodiments of the present disclosure.

FIG. 6B illustrates a listing showing formulation of a rule according to some embodiments of the present disclosure.

FIG. 6C illustrates a listing showing queries to be executed for the theory shown in the listing of FIG. 6B according to some embodiments of the present disclosure.

FIG. 7 illustrates an example algorithm for proof explanation generation by querying vocabularies and projecting results for the example case described in FIG. 6A-6C.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Industry compliance reporting trends reveal that a consistent evidence of regulatory compliance is to be provided to auditors, whereas enterprise management expects an accurate and succinct assessment of risks associated with compliance. Also, explanations of proofs of (non-) compliance may be expected to include regulations that a given operational practice of an enterprise is subjected to, the parts of a regulation that are departed from and reasons for such departure. The latter functionality is especially relevant for shareholders since it forces an enterprise to give business reasons for (non-) compliance. Various embodiments disclosed herein provides elaborate explanation of proof of (non-) compliance, thereby providing robust approach for compliance checking. For instance, various embodiments provide techniques for modeling and mapping of concepts (or conceptual mapping) in regulations and operational practices, and utilize the same for generating proofs of compliance and/or non-compliance.

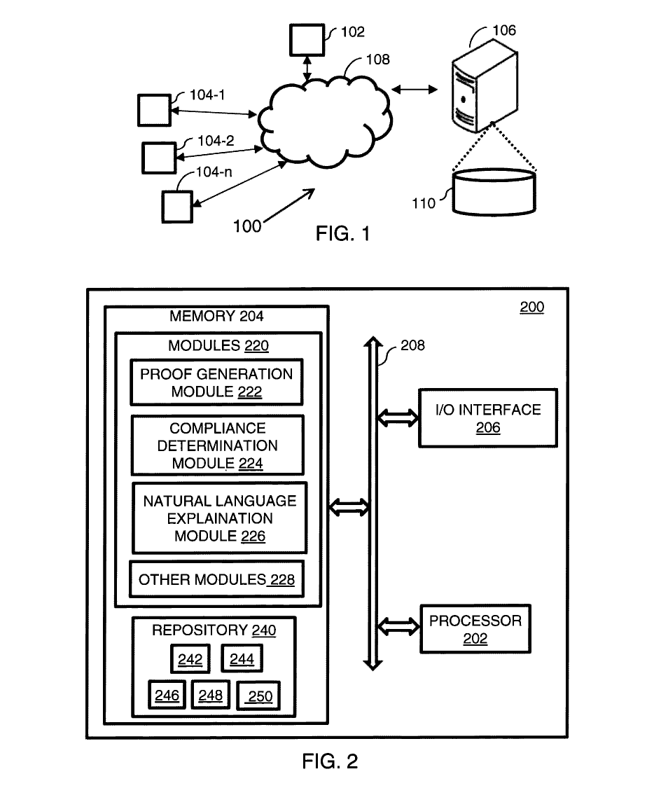

The embodiments herein provide a system and method for regulatory compliance management to generate proof explanation of regulatory compliance and/or non-compliance, in a natural language. For example, the embodiments provide method and system to identify mapping between vocabularies associated with enterprises operations and regulations based on semantics of business vocabulary to indicate where and when in the operational models of enterprise should the regulatory checks be enacted. Further, based on the mapping, the embodiments disclose generation of proofs of regulatory (non-) compliance by specifying the rules, for example, in a compliance determination engine. The vocabulary features of concepts contained in proofs may be queried to generate natural language statements of proof. The projected results may be substituted into natural language templates to generate the proofs of (non-) compliance in natural language. An example network implementation for explanation of proof of non-compliance in natural language is described further with reference to FIG. 1

Referring now to the drawings, and more particularly to FIGS. 1 through 7, where similar reference characters denote corresponding features consistently throughout the figures, there are shown preferred embodiments and these embodiments are described in the context of the following exemplary system and/or method.

FIG. 1 illustrates a network implementation 100 of a regulatory compliance management system, for example, a system 102 in accordance with an example embodiment. Herein, the regulatory compliance management includes checking compliance and/or a non-compliance of regulation and/or conditions and/or rules. Upon checking the compliance or non-compliance, if it is determined that a regulation is met, it may be termed as a ‘success’ or ‘compliance success’. On the contrary, if it is determined that the regulation is not met, it may be termed as a ‘failure’ or ‘compliance failure’.

In an embodiment, the network implementation 100 includes a plurality of computing devices which can access the system 102. It should be noted that the term “computing devices” can be referred to as encompassing one or more client devices, one or more physical and/or virtual servers, cloud computing devices and/or other components in the system 100. For example, the network implementation 100 includes computing devices, which may be user devices such as user devices 104-1, 104-2 . . . 104-N, and server(s) such as server 106, connected over a communication network such as a network 108.

The servers, such as the server 106, include but are not limited to application servers, database servers, computation farms, data centers, virtual machines, cloud computing devices, mail or web servers and the like. The server 106 includes one or more computing devices or machines capable of operating one or more Web-based and/or non-Web-based applications that may be accessed by other computing devices (e.g. client devices, other servers) via the network 108. One or more servers 106 may be front end Web servers, application servers, and/or database servers. Such data includes, but is not limited to Web page(s), image(s) of physical objects, user account information, and any other objects and information. It should be noted that the server 106 may perform other tasks and provide other types of resources.

The server 106 may include a cluster of a plurality of servers which are managed by a network traffic device such as a firewall, load balancer, web accelerator, gateway device, router, hub and the like. In an aspect, the server 106 may implement a version of Microsoft® IIS servers, RADIUS servers and/or Apache® servers, although other types of servers may be used and other types of applications may be available on the servers 106.

In an embodiment, the network implementation 100 includes one or more databases such as a database 110, communicatively coupled to the servers 106. The database 110 may be configured to allow storage and access to data, files or otherwise information utilized or produced by the system 102. Herein, it is assumed that the database 110 is embodied in computing devices configured external to the servers 106. It will however be noted that in alternative embodiments, the databases 110 may be embodied in the servers 106.

The system 102 may be accessed by multiple users through one or more user devices 104-1, 104-2 . . . 104-N, collectively referred to as user devices 104 hereinafter, or applications residing on the user devices 104. In one implementation, the system 102 may include a cloud-based computing environment in which a user may operate individual computing systems configured to execute remotely located applications. Examples of the user devices 104 may include, but are not limited to, a portable computer, a personal digital assistant (PDA), a handheld device, and a workstation. Herein, the network environment 100 is shown to include a limited number of user devices, such as user devices 104-1, 104-2 . . . 104-N, however, it will be understood that the network environment 100 may include any other numbers and types of devices in other arrangements, without limiting the scope of the various embodiments disclosed herein.

In an aspect, the user device 104 may be configured to run a Web browser or other software module that provides a user interface for human users to interact with and access the system 102, as will be described in more detail below. For example, the client device may include a locally stored mobile application which allows the user to request resources and/or information via the mobile application.

The user devices 104 are communicatively coupled to the system 102 through the network 108. In one implementation, the network 108 may be a wireless network, a wired network or a combination thereof. The network 108 can be implemented as one of the different types of networks, such as intranet, local area network (LAN), wide area network (WAN), the internet, and the like. The network 108 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 108 may include a variety of network devices, including routers, bridges, servers, computing devices, storage devices, and the like.

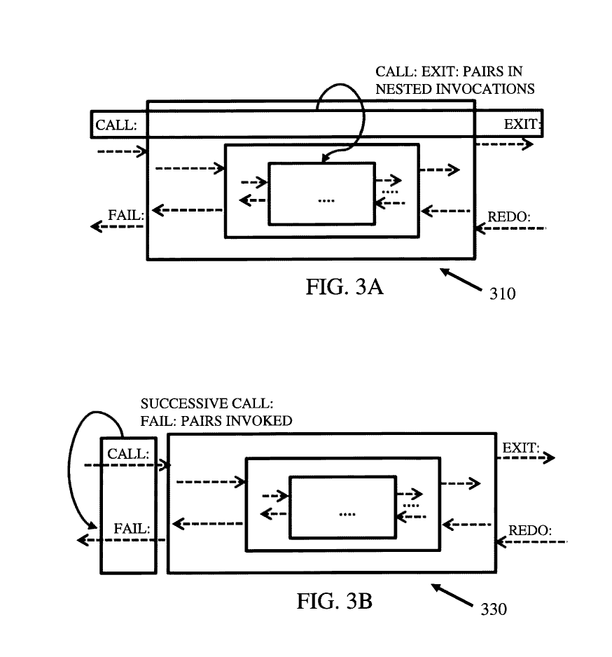

FIG. 2 illustrates a block diagram of a system 200 for generation of proof explanation in regulatory compliance management, in accordance with an example embodiment. The system 200 may be an example of the system 102 (FIG. 1). In an example embodiment, the system 200 may be embodied in, or is in direct communication with the system, for example the system 102 (FIG. 1). The system 200 includes or is otherwise in communication with one or more hardware processors such as a processor 202, one or more memories such as a memory 204, and an I/O interface 206. The processor 202, memory 204, and the I/O interface 206 may be coupled by a system bus such as a system bus 208 or a similar mechanism.

The I/O interface 206 may include a variety of software and hardware interfaces, for example, a web interface, a graphical user interface, and the like. The interfaces 206 may include a variety of software and hardware interfaces, for example, interfaces for peripheral device(s), such as a keyboard, a mouse, an external memory, a camera device, and a printer. Further, the interfaces 206 may enable the system 102 to communicate with other devices, such as web servers and external databases. The Interfaces 206 can facilitate multiple communications within a wide variety of networks and protocol types, including wired networks, for example, local area network (LAN), cable, etc., and wireless networks, such as Wireless LAN (WLAN), cellular, or satellite. For the purpose, the interfaces 206 may include one or more ports for connecting a number of computing systems with one another or to another server computer. The I/O interface 206 may include one or more ports for connecting a number of devices to one another or to another server.

The hardware processor 202 may be implemented as one or more microprocessors, microcomputers, microcontrollers, digital signal processors, central processing units, state machines, logic circuitries, and/or any devices that manipulate signals based on operational instructions. Among other capabilities, the hardware processor 202 is configured to fetch and execute computer-readable instructions stored in the memory 204.

The memory 204 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 204 includes a plurality of modules 220 and a repository 240 for storing data processed, received, and generated by one or more of the modules 220. The modules 220 may include routines, programs, objects, components, data structures, and so on, which perform particular tasks or implement particular abstract data types. In one implementation, the modules 220 may include programs or coded instructions that supplement applications and functions of the system 200.

In one implementation, the modules 220 may include a proof generation module 222, a compliance determination module 224, and a natural language explanation module 226, and other modules 228. The repository 240, amongst other things, includes a system database 242 and other data 244. The other data 244 may include data generated as a result of the execution of one or more modules 220. The repository 240 is further configured to maintain an operations dictionary 246, a regulations dictionary 248, and a terminological dictionary 250.

In an embodiment, the system 200 is capable of checking for compliance or a non-compliance of regulation/conditions/rules. Additionally, the system 200 can generate proof(s) of the compliance and/or the non-compliance rooted in formal logic and explicates the same in natural language. Finally, the system 200 generates a generate natural language explanations of said proof(s) for regulatory compliance management. A detailed description of functioning of the system 200 for regulatory compliance management is described below.

In an embodiment, for regulatory compliance management, at first, the system 200 is caused to model an operations dictionary 246 by identifying a first set of discriminative words from business facts data of an enterprise. In an embodiment, the first set of discriminative words is indicative of a plurality of concepts in the business facts data. The operations dictionary 246 or vocabulary of the enterprises' operations data (hereinafter referred to as ‘operations dictionary’) may be derived from the business process models of the enterprise.

Additionally, the system 200 models a regulations dictionary by identifying a second set of discriminative words from a regulatory rules data. The regulatory rules data is associated with compliance rules of the enterprise. Herein, the regulations dictionary or the second vocabulary of the regulations (hereinafter referred to as ‘regulations dictionary) may be derived from regulations information associated with the processes of the business enterprise. In an embodiment, the system 200 maps the first vocabulary with the second vocabulary based on Semantics of Business Vocabulary and Rule (SBVR) standard.

In an embodiment, the SBVR is utilized to model and map vocabularies of regulations and enterprises' operations, to thereby generate a semantic model for a formal terminology. In particular, the SBVR model provides a cohesive set of interconnected concepts with behavioral guidance in terms of policies and rules to govern actions of subject of the formal terminology. In an embodiment, the enterprise operations data can be encoded as ‘facts’ (or operations facts) in the operations vocabulary, and the regulations (or regulation rules) as ‘rules’ in the regulations vocabulary. The enterprise operations data expressed as ‘facts’ can be checked against regulation rules using the terminological mapping of the regulation and enterprise operational vocabulary, which are distinct.

The system 200 is caused to model a terminological dictionary having terminological variations of the plurality of concepts and natural language statements associated with the regulatory rules data. For example, the terminological dictionary includes a list of verb concept wordings corresponding to a plurality of tasks associated with the enterprise data and corresponding to each object and condition label in the enterprise data.

The mapping of the regulations with the enterprise operations can be utilized for generating the proof of (non-)compliance checking. In an embodiment, the proof can be generated by a proof generation engine, for example, a DR-Prolog model. In an embodiment, the proof generation engine may be embodied in the system as a proof generation module configured with the processor 204. Alternatively, the proof generation engine may be coupled with system 200, and may configure to generate proofs of compliance and/or non-compliance and send the generated proof to the system for generation of explanation of the proofs. In an example embodiment, the proof generation approach is based on arriving at a specific rules and facts that imply a ‘success’ or ‘failure’. The result of compliance checking may be in form of a ‘yes’ or a ‘no’, where ‘yes’ may imply a success and ‘no’ may imply a failure.

In an embodiment, in order to generate the proof, the system 200 may utilize a meta-program to generate a listing of sequence of instructions and result thereof, executed by the proof generation engine, called an interpretation trace (hereinafter referred to as a trace), and another program may be utilized to process the trace and generate success facts and rules and failure facts and rules. In an embodiment, a trace producing meta-interpreter can be used for generating success facts and rules and failure facts and rules. In an embodiment, the proof of one of a compliance and non-compliance in form of one of success rules and failure rules respectively, and corresponding facts can be obtained from a compliance determination engine. In an embodiment, the compliance determination engine can be embodied in the system 200 as a compliance determination module 224 in the memory 202. Alternatively, the compliance determination engine can be communicatively coupled to the system 200. An example algorithm for generating success rules and facts from success trace is given as under. It will be noted that a similar algorithm for generating the failure rules and facts from the failure trace may be implemented:

Algorithm 1: Get Success Rule and Facts from Success Trace

Input: Texts of success trace and theory
Output: Success rules and success facts
1 Trace trace←read(successTrace.txt), Theory theory←read(theory.txt)
2 procedure processTrace(Trace trace)
3 while trace.hasFail( ) do
4 depth←computeMaxDepth(trace)
5 if !depth 0 then
6 trace.tag(get_CALL_FAIL_Pairs( ))
7 depth←depth−1
8 trace.remove(get_CALL_FAIL_Pairs( ))
10 processTrace(trace)
12 return
13 procedure matchRules(Trace t, Theory theory)
14 if t.predicate.startsWith(“defeasible” or “strict”) then
15 for n=0 to theory.length( ) do
16 th←theory.line( )
17 if match(t.rulelden f ier( ), th) then
18 successRules.add(th)
19 procedure matchFacts(Trace t, Theory theory)
20 if t.predicate.startsWith(“f act”) then
21 for n=0 to theory.length do
22 th←theory.line
23 if match(t, th) then
24 successFacts.add(th)
25 processTrace(trace)
//Only CALL EXIT pairs left in the trace.
26 for n=0 to trace.length( )−1 do
27 t←trace.line( )
28 matchRules(trace, theory)
29 matchFacts(trace, theory)
30 return successRules,successFacts

In an example embodiment, a trace is produced by the meta-interpreter that minimally includes three pieces of information, namely, depth of predicate invocation, the invocation type which is one of CALL, EXIT, FAIL, and REDO, and the current predicate being processed. An example of trace is shown below.

0‘CALL’defeasibly(client_account_data(17,open_account),obligation)
1 ‘CALL’strictly(client_account_data(17,open_account),obligation)
2‘CALL’fact(obligation(client_account_data(17,open_account)))
2‘FAIL’fact(obligation(client_account_data(17,open_account)))

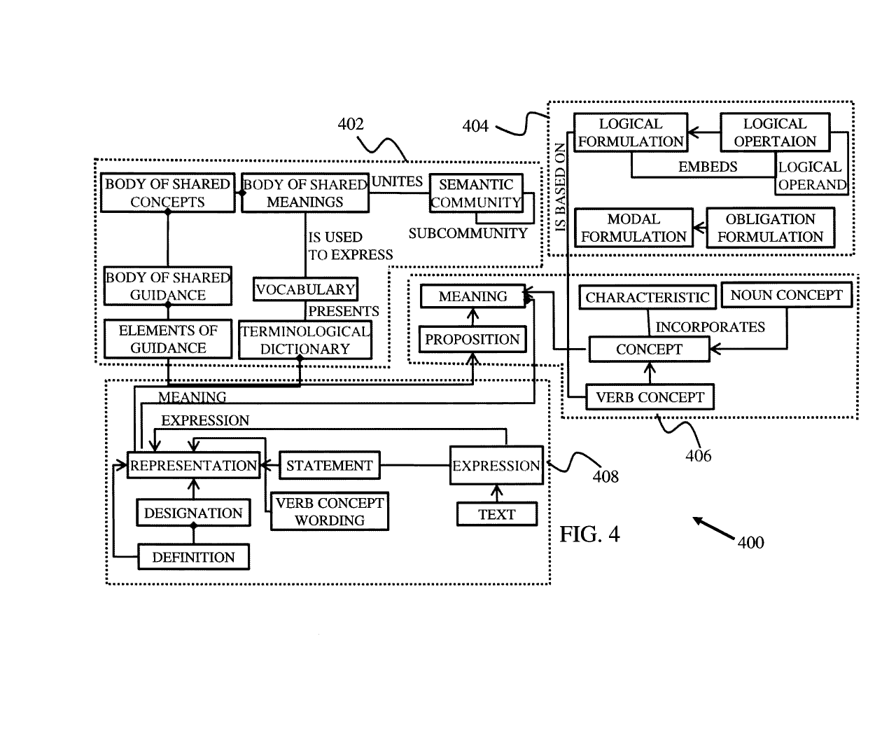

An example representation illustrating generation of specific success or failure rules and facts is described further with reference to FIGS. 3A and 3B.

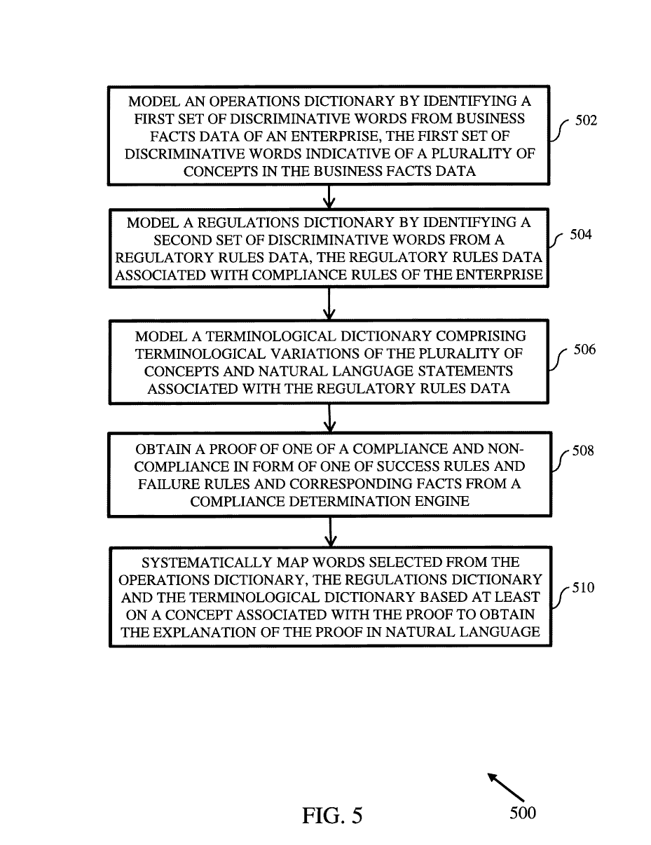

The system 200 is caused to query the formal terminology model (or the DR-Prolog model) for concepts in the proof of (non-)compliance. In an embodiment, the system may systematically map words selected from the operations dictionary, the regulations dictionary and the terminological dictionary based at least on the concept associated with the proof to obtain the explanation of the proof in natural language. The results from queries to formal terminology model are achieved close to the natural language explanation of the proof, and said natural language explanation can be projected. An example of generating natural language explanations of the proof is described further with reference to FIG. 4.

FIGS. 3A and 3B illustrate procedure box abstractions 310 and 330, respectively, used to represent procedure calls to the logic predicates in the rules, using the keywords ‘CALL’, ‘EXIT’, ‘FAIL’ and ‘REDO’ for regulatory compliance management in accordance with an example embodiment. The procedure box abstraction (for example, the procedure box abstractions 210 and 230) is represented in the trace by the depth of invocation. CALL, EXIT, FAIL, and REDO indicate the time when predicate is entered/invoked, successfully returned from, completely failed, or failed but backtracked respectively. The meta-interpreter can be used to produce trace that can be saved as a text file where each line indicates one invocation with three pieces of information each.

Referring now collectively to FIGS. 1, 3A and 3B, algorithm 1 show how a success trace is processed to recursively remove successive CALL and FAIL pairs. The CALL and FAIL pairs indicate failed invocations and thus may not be relevant for obtaining success rules and facts. Said CALL and FAIL pairs may occur at various depth of nesting where the invocation occurs bound by a maximum depth that recursive invocations led to. In algorithm 1, CALL FAIL pairs are first tagged at a maximum current depth for removal, indicated by innermost procedure box and then the CALL FAIL pairs are proceeded till a lowest depth, indicated by outermost procedure box. Recursive calls in algorithm 1 are needed to ensure that all CALL FAIL pairs at various depths are removed. Once all CALL FAIL pairs are removed, a successive CALL EXIT pair in the remaining trace indicate successful invocation of rules and facts as illustrated in FIG. 3A.

Referring now to FIG. 3B, in another example, to find specific failed rules and facts, instead of removing successive CALL FAIL pairs, only the CALL FAIL pairs are retained and other kinds of invocations are removed. The successive CALL FAIL pairs in case of failed rules and facts are captured and are not recursed as in Algorithm 1.

In another embodiment, similar to algorithm 1 (discussed with reference to FIG. 1) for success rules and facts, failure rules and facts have a trace of failed query as input. The rules and facts are matched with the theory of the problem which is stored line by line itself by calling the match*( ) methods. The trace contains intermediate substitutions by an inference engine that enables drawing inferences from successive invocations of logical predicates. The strings of invocations of rules and facts from the trace are matched partially with the rules and facts from the theory. The output of algorithms (pertaining to success and failure) in embodiments discussed with reference to FIGS. 3A and 3B, are sets of matched rules and facts from the theory rather than the trace.

The results from trace are output as success facts and rules or failure facts and rules, which may be presented in form of natural language explanation of the proof. An example embodiment for presenting the proof in form of natural language explanation is explained further with reference to FIG. 4.

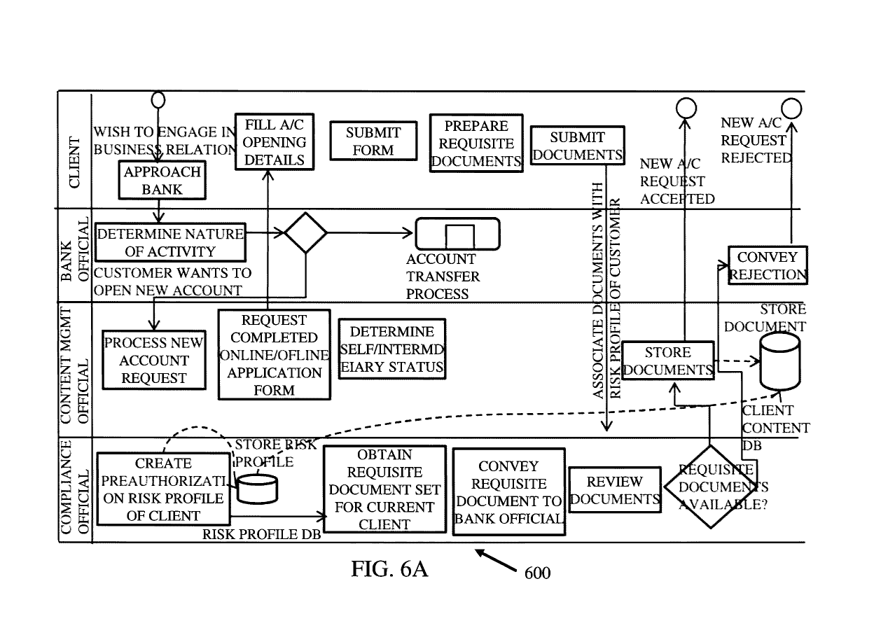

FIG. 4 illustrates an example representation of building the vocabulary for natural language explanations pertaining to regulatory compliance proof generation, in accordance with an example embodiment. In an embodiment, the successful or failed rules and facts are used to generate explanations via vocabularies. Modeling and mapping regulations and operations vocabularies (SBVR vocabularies) for regulations and operations are defined in terms of four sections. In one embodiment, vocabulary to capture the business context is created, consisting of the semantic community and sub-communities owning the regulation and to which the regulation applies. Each semantic community is unified by shared understanding of an area, i.e., body of shared meanings. The body of shared meanings in turn includes smaller bodies of meaning, containing a body of shared concepts that captures concepts and their relations, and a body of shared guidance containing business rules. These concepts represent Business Vocabulary 402 in the SBVR meta-model in FIG. 5.

In addition, a body of concepts including the key terms of the regulatory rules is modeled by the system (for example, the system 200). The body of concepts including the key terms of regulatory rules is modeled as noun concepts. Each of these noun concepts are categorized based on their characteristics into an entity which is defined by a general concept. Each of the noun concepts is associated with verb concepts which capture the behavior of the noun concept. A binary verb concept captures relations between two noun concepts or two verb concepts from the body of concepts. A unary verb concept is used to capture the characteristics of the verb concepts from the body of concepts. The SBVR meta-model for modeling regulation body of concepts are shown as Meaning and Representation Vocabulary 406 as shown in FIG. 4.

Also, a body of guidance is built using rules/policies laid down in the regulation. The body of guidance includes logical formulation of each policy (an obligation formulation for obligatory rules) based on logical operations such as conjunctions, implications and negation. At the lowest level are atomic formulations which are the basic building blocks used to form logical expressions. An atomic formulation is based on the verb concepts from the body of concepts from the vocabulary as shown in Business Rules Vocabulary or Logical Formulation Semantics 404 in FIG. 4.

In addition, a terminological dictionary 408 containing various representations of various concepts from the body of concepts is modelled for use by a semantic community (for example, a regulatory body or an enterprise) for its concepts and rules. For example, the terminological dictionary consists of designations or alternate names for various concepts, definitions for concepts and natural language statements for policies stated in the regulation. The terminological dictionary is used to capture the vocabulary used by the enterprise in its business processes. Each activity of the business process is represented as a verb concept wording in the terminological dictionary. In an example embodiment, SBVR concepts for modeling terminological variations are shown as Terminological Dictionary 408 in FIG. 4. SBVR defines verb concept wordings from the regulation body of concepts as representations of verb concepts in their most general form. Every verb concept in the regulation body of concepts is mapped to corresponding verb concept wording from the process terminological dictionary of the enterprise business processes. The mapping is used to look up consequent terms of rules from the regulations and the corresponding process entity from the business processes. The mapping of rules from the regulations using verb concepts from the body of verbs and the verb concept wordings from the enterprise business processes is most essential for compliance implementation. The success rules and facts or the failure rules and facts which are generated using a meta-program for a trace are to be mapped with the vocabularies generated from regulations and operations by a semantic model (SBVR) to elaborate the proof generated in a natural language. Referring to FIG. 3, the mapping between concepts defined using the Business Vocabulary 402 of the body of concepts, rules defined using the Business Rules Vocabulary 404, and the terminological variations of concepts defined using the Terminological Dictionary 408 of enterprise business processes is used as the source of the proof explanation.

In an embodiment, as illustrated in FIG. 4, to obtain the natural language explanation for a success rules and facts or failure rules and facts, each term/keyword of the rules/facts is looked up in the Business Vocabulary 402 of the body of concepts and its corresponding terminological representation in the Terminological Dictionary 408 of enterprise business processes. For rules, logical formulation of rule is fetched from Business Rules Vocabulary 404 and it natural language representation is obtained from its corresponding mappings in the Terminological Dictionary 408.

An example flowchart illustrating a method for regulatory compliance management is described further with reference to FIG. 5.

FIG. 5 illustrates a flow chart of a method for generation of proof explanation in regulatory compliance management in accordance with an example embodiment. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communication network. The order in which the method 500 is described is not intended to be construed as a limitation, and any number of the described method blocks can be combined in any order to implement the method 500, or an alternative method. Furthermore, the method 500 can be implemented in any suitable hardware, software, firmware, or combination thereof. In an embodiment, the method 500 depicted in the flow chart may be executed by a system, for example, the system 200 of FIG. 2. In an example embodiment, the system 200 may be embodied in a computing device, for example, the computing device 104 (FIG. 1).

At 502, the method 500 includes modeling an operations dictionary by identifying a first set of discriminative words from business facts data of an enterprise. The first set of discriminative words is indicative of a plurality of concepts in the business facts data. In an embodiment, the operations dictionary may include vocabulary to capture business context. Said vocabulary includes semantic community and sub-communities owning the regulation and to which the regulation applies. Each semantic community is unified by shared understanding of an area, i.e., body of shared meanings. This in turn can comprise smaller bodies of meanings, containing a body of shared concepts that captures concepts and their relations, and a body of shared guidance containing business rules. In FIG. 4, the concepts are illustrated as Business Vocabulary. In an embodiment, the body of concepts is modeled by focusing on key terms in regulatory rules, as described with reference to FIG. 4.

At 504, the method 500 includes modeling a regulations dictionary by identifying a second set of discriminative words from a regulatory rules data. The regulatory rules data is associated with compliance rules of the enterprise. In an embodiment, the operations dictionary and the regulations dictionary may be modelled using SBVR.

In an embodiment, the regulations dictionary may include the body of guidance, and may build using policies laid down in the regulation. The regulations dictionary may include logical formulation of each policy (an obligation formulation for obligatory rules) based on logical operations such as conjunctions, implications and negation. At the lowest level are atomic formulations based on verb concepts from the body of concepts. This is shown in Business Rules Vocabulary in FIG. 4.

At 506, the method 500 includes modelling a terminological dictionary having terminological variations of the plurality of concepts and natural language statements associated with the regulatory rules data. The terminological dictionary contains various representations used by a semantic community for its concepts and rules. For example, the terminological dictionary consists of designations or alternate names for various concepts, definitions for concepts and natural language statements for policies stated in the regulation. The terminological dictionary may also capture the vocabulary used by the enterprise in its business processes. Each activity in the process becomes a verb concept wording in the terminological dictionary. SBVR concepts for modeling terminological variations are shown as Terminological Dictionary in FIG. 4.

SBVR defines verb concept wordings as representations of verb concepts in their most general form. Every verb concept in the regulation body of concepts is mapped to corresponding verb concept wording from the process terminological dictionary. This mapping is used to look up consequent terms of rules and the corresponding process entity is treated as a placeholder for compliance implementation of the rule.

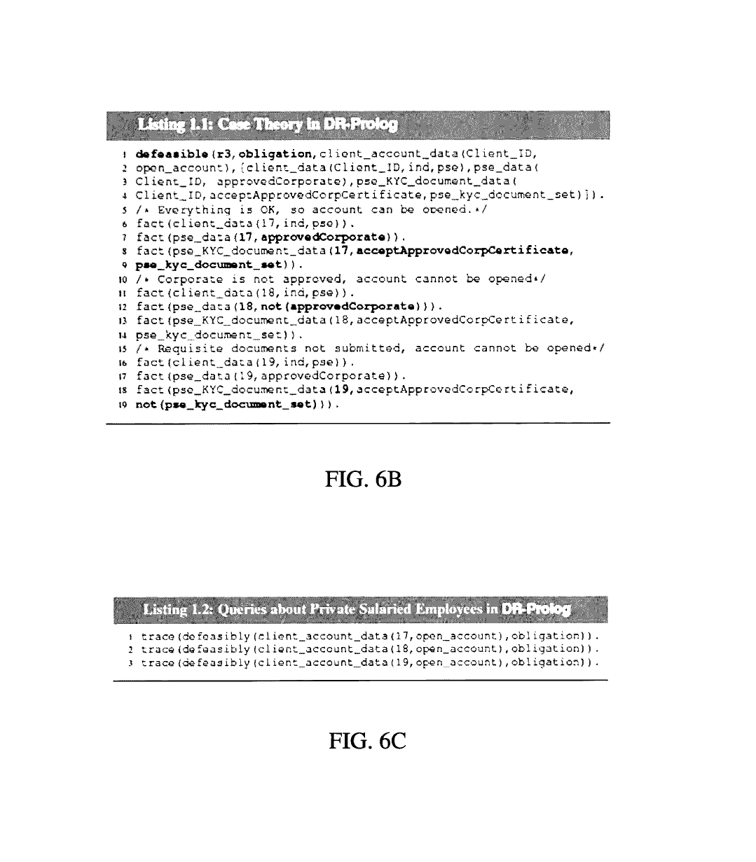

At 508, the method 500 includes obtaining a proof of one of a compliance and non-compliance in form of one of success rules and failure rules and corresponding facts from a compliance determination engine. At 510, the method 500 includes systematically mapping words selected from the operations dictionary, the regulations dictionary and the terminological dictionary based at least on a concept associated with the proof to obtain the explanation of the proof in natural language. Herein, the mapping between concepts defined using the Business Vocabulary, rules defined using the Business Rules Vocabulary, and the terminological variations of concepts defined using the Terminological Dictionary is used as the source of the proof explanation. In order to obtain the explanation for a success or failure fact, each term/keyword in the fact is looked up in the Business Vocabulary body of concepts and its corresponding terminological representation in terminological dictionary. For rules, logical formulation of rule is fetched from Business Rules Vocabulary and it natural language representation is obtained from its corresponding mappings in the terminological dictionary. An example case study representing the method for regulatory compliance management being performed in a banking environment is further described with reference to FIGS. 6A-6C.

FIG. 6A illustrate an example workflow 600 for regulatory compliance management in a banking environment in accordance with an example embodiment. In the present example, the regulatory compliance is explained by using an example of RBI's KYC regulations.

RBI's KYC regulations are aimed at identifying different types of customers, accepting them as customers of given bank when they fulfill certain identity and address documentation criteria laid out in various regulations and annexes in the most recent RBI KYC master circular, and categorizing them into various risk profiles for periodic KYC reviews. An example of how KYC regulations characterize a salaried employee working at a private company and which documents are acceptable for opening a new account by such individual, is described below:

[ . . . for opening bank accounts of salaried employees some banks rely on a certificate/letter issued by the employer as the only KYC document . . . , banks need to rely on such certification only from corporates and other entities of repute and should be aware of the competent authority designated by the concerned employer to issue such certificate/l letter. Further, in addition to the certificate from employer, banks should insist on at least one of the officially valid documents as provided in the Prevention of Money Laundering Rules (viz. passport, driving licence, PAN Card, Voters Identity card etc.) or utility bills for KYC purposes for opening bank account of salaried employees of corporates and other entities.]

As illustrated in FIG. 6A, a business process (BP) model of a BankA where individuals of the kind private salaried employee desire to open account is shown. A general bank official interacts with a client while KYC documents are managed by content management official. The compliance official is in charge of compliance function. This BP model is traversed to generate BankA Terminological Dictionary which is in the form of a list of verb concept wordings corresponding to a) each Task/SubProcess from the process, e.g., Approach Bank, Process Newaccount Request and b) each object and condition label in the process, e.g., Client Risk Profile Database, Self, Intermediary, and so on.

Vocabularies for the KYC regulations and specifically regulation §2.5 (vii), and the account opening business process, can be modeled and mapped as described below.

Business vocabulary consists of the semantic community banking industry, with sub-communities RBI and BankA. The RBI semantic community is unified by body of shared meanings RBI_Regulations. It contains the body of meanings RBI_KYCRegulation which includes body of shared concepts RBI_KYCRegulationConcepts and body of shared guidance RBI_KYCRules. Process concepts such as ReviewDocuments are captured as verb concept wordings in Terminological Dictionary of BankA. Finally, Terminological Dictionary BI_Terminological_Reference contains natural language representation of various KYC concepts.

FIG. 6B illustrates a listing showing formulation of a rule, in accordance with an example embodiment. Listing 1.1 shows a formulation of a rule for private salaried employee from KYC regulation stated above. The formulation may be derived from a compliance processing engine, such as DR-Prolog. Herein, three different cases are captured in Listing 1.1. In the example shown here, the regulation is complied with for individual 17 whereas conditions for individuals 18 and 19 results in non-compliance.

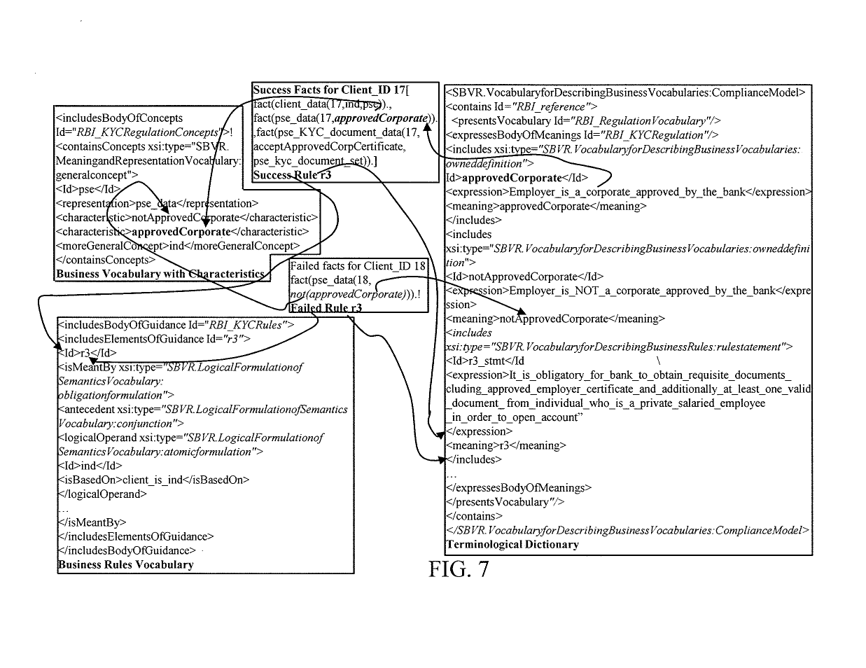

FIG. 6C illustrates a listing 1.2 showing queries that can be executed for the theory shown in Listing 1.1. The traces can be collected and input to the program implementing Algorithm 1 and also to obtain failure rules and facts along with the theory for generating proofs. The success/failure rules and facts are then parsed to obtain terms. These terms are then used in a manner illustrated in FIG. 7.

Referring now to FIG. 7, proof explanation generation by querying vocabularies and projecting results is explained for the example case described in FIG. 6A. Business Vocabulary with Characteristics on top left of FIG. 7 shows regulation body of concepts, containing the concept hierarchy with client at its root, specialized by general concept individual, specialized by concept pse denoting private salaried employee. Concept pse_KYC_document denotes the documents submitted by a private salaried employee. Characteristics of private salaried employee are whether employer is an approvedCorporate or notApprovedCorporate. Verb concepts client is_ind, client_is_pse and pse_has_pse_KYC_document capture relations between concepts.

Business Rules Vocabulary on the bottom left of FIG. 7 includes the body of guidance containing a section of regulation policy denoted by rule r3 in Listing 1.1. Rule r3 is defined as an obligation formulation based on an implication, with antecedent list client_is_ind, client_is_pse, approvedCorporate and acceptApprovedCorpCertificate and consequent open_account.

The Terminological Dictionary is shown to include alternate names client_data, pse_data, pse_KYC_document_data for concepts client, pse and pse_KYC_document respectively. It also includes the descriptions Customer, Private salaried employee and KYC document details for private salaried employee and definitions such as ‘Employer is a corporate approved by the bank’ and ‘Certificate from approved corporate can be accepted’ for characteristics approvedCorporate and acceptApprovedCorpCertificate respectively.

Each concept is mapped to its corresponding representation in the Terminological Dictionary. Similarly, each rule in Business Rules Vocabulary is mapped to its natural language statement in the Terminological Dictionary. This mapping leads to attaching the rule r3 in Listing 1.1 at the activity Review Documents indicated by 1 in the BP model shown earlier in FIG. 6A.

Various XML fragments shown in FIG. 7 can be treated as tables with mapping concepts as foreign keys. Upon querying specific terms from respective tables/XML fragments, projecting the natural language expressions including the rule statements, and performing textual processing including removing_underscore characters; for case 1 in FIG. 7 of success rules and facts, the following explanation can be obtained:

As per rule Q, it is obligatory for bank to obtain requisite documents including approved employer certificate and additionally at least one valid document from individual who is a private salaried employee in order to open account for this individual. For current individual that is private salaried employee; Employer is a corporate approved by the bank and KYC documents required for private salaried employee submitted. Therefore compliance is achieved for current individual with Client_ID 17.

Similarly for case 2 of failure rules and facts, the following explanation is obtained: For current individual that is private salaried employee; Employer is NOT a corporate approved by the bank and KYC documents required for private salaried employee submitted. As per rule r, it is obligatory for bank to obtain requisite documents including approved employer certificate and additionally at least one valid document from individual who is a private salaried employee in order to open account for this individual. Therefore compliance is NOT achieved for current individual with Client ID 18. The underlined parts of the explanation are blanks in a textual template filled in with the results of projection. It will be understood that the explanations above can be made to contain additional information such as regulation number (RBI KYC Customer Identification 2014 §2.5 (vii)), risks identified by regulatory body for given case (“ . . . accepting documents from an unapproved corporate is fraught with risk . . . ”) by modeling this information in the Terminological Dictionary. To implement vocabulary artifacts, elements can be imported from the consumable XMI of SBVR meta-model available at OMG site3 into Eclipse Modeling Framework Ecore model. The BP model is created and traversed. DR-Prolog programs can be implemented using TuProlog.4 Algorithm 1 and also similar algorithm for capturing failure rules and facts can be implemented in Java. For loading and querying XML fragments shown in FIG. 5, and projecting results into templates used Apache Metamodel5 can be used which may take the XML representation of vocabularies modeled with standard Ecore editor. It provides SQL like query API to query XML data. Results of queries are substituted into textual template(s) using FreeMarker6 Java template engine.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

Various embodiments disclosed herein provide method and system for generation of proof explanation in regulatory compliance management. In embodiment, the system uses Semantics of Business Vocabulary and Rules (SBVR) to model and map vocabularies of regulations and operations of enterprise. Using said vocabularies and leveraging proof generation abilities of a compliance determination engine, the system create explanation of the proof of (non-) compliance. Basic natural language explanations can be easily enriched by adding requisite domain knowledge to the vocabularies. An important contribution of the disclosed embodiments is that the disclosed embodiments enables providing proof and explain (non-)compliance, preferably in a way tailored to specific stakeholders' requirements. Such explanation may be utilized by the business stakeholders to find out how (non-)compliance is affecting business goals that are currently operationalized. In order to obtain explanations in natural language, the system models and maps concepts from legal and operational practices from regulations and business processes. In addition, system models additional domain knowledge other than knowledge expressed in compliance rules to enrich explanations and increase their value to the stakeholders. Herein, because of generic-ness of the vocabularies, the natural language explanations can be tailored to the language of the usage domain by explicating domain-specific terms in the vocabulary, thus resulting in domain-specific natural language explanation. In particular, the vocabularies that are create are comprehensive that not only enable capturing rules and operations specific vocabularies and mapping between them, but also store fine granular natural language excerpts which are used to generate the explanation.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are Intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor implemented method for generating explanation of proofs associated with regulatory information, the method comprising:
modeling, via one or more hardware processors, an operations dictionary by identifying a first set of discriminative words from business facts data of an enterprise, the first set of discriminative words indicative of a plurality of concepts in the business facts data;
modeling, via the one or more hardware processors, a regulations dictionary by identifying a second set of discriminative words from a regulatory rules data, the regulatory rules data associated with compliance rules of the enterprise;
modeling, via the one or more hardware processors, a terminological dictionary comprising terminological variations of the plurality of concepts and natural language statements associated with the regulatory rules data;
obtaining a proof of one of a compliance and non-compliance in form of one of success rules and failure rules and corresponding facts from a compliance determination engine, via the one or more hardware processors; and
systematically mapping, via the one or more hardware processors, words selected from the operations dictionary, the regulations dictionary and the terminological dictionary based at least on a concept of the plurality of concepts in the proof to obtain the explanation of the proof in natural language.

2. The method of claim 1, wherein identifying the first set of discriminative words comprises parsing the business facts data to obtain the corresponding facts.

3. The method of claim 1, wherein identifying the second set of discriminative words comprises parsing the regulatory rules data to obtain the success rules and the failure rules.

4. The method of claim 1, wherein the terminological dictionary comprises a list of verb concept wordings corresponding to a plurality of tasks associated with the enterprise data and corresponding to each object and condition label in the enterprise data.

5. The method of claim 4, wherein systematically mapping the words comprises:
mapping each concept of the plurality of concepts to a corresponding representation in the terminological dictionary; and
mapping a plurality of rules associated with the regulatory rules data in the regulations dictionary to a corresponding natural language statement associated with the regulations dictionary in the terminological dictionary.

6. A system for generating explanation of proofs associated with regulatory information, the system comprising:
one or more memories storing instructions; and
one or more hardware processors coupled to said one or more memories, wherein the one or more hardware processors configured by said instructions to:
model an operations dictionary by identifying a first set of discriminative words from business facts data of an enterprise, the first set of discriminative words indicative of a plurality of concepts in the business facts data;
model a regulations dictionary by identifying a second set of discriminative words from a regulatory rules data, the regulatory rules data associated with compliance rules of the enterprise;
model a terminological dictionary comprising terminological variations of the plurality of concepts and natural language statements associated with the regulatory rules data;
obtain a proof of one of a compliance and non-compliance in form of one of success rules and failure rules and corresponding facts from a compliance determination engine; and
systematically map words selected from the operations dictionary, the regulations dictionary and the terminological dictionary based at least on a concept associated with the proof to obtain the explanation of the proof in natural language.

7. The system of claim 6, wherein to identify the first set of discriminative words, the one or more hardware processors are configured by said instructions to parse the business facts data to obtain the corresponding facts.

8. The system of claim 6, wherein to identify the second set of discriminative words, the one or more hardware processors are configured by said instructions to parse the regulatory rules data to obtain the success rules and the failure rules.

9. The system of claim 6, wherein the terminological dictionary comprises a list of verb concept wordings corresponding to a plurality of tasks associated with the enterprise data and corresponding to each object and condition label in the enterprise data.

10. The system of claim 9, wherein to systematically map the words, the one or more hardware processors are configured by said instructions to:
map each concept of the plurality of concepts to a corresponding representation in the terminological dictionary; and
map a plurality of rules associated with the regulatory rules data in the regulations dictionary to a corresponding natural language statement associated with the regulations dictionary in the terminological dictionary.

11. A non-transitory computer-readable medium having embodied thereon a computer program for executing a method for generating explanation of proofs associated with regulatory information, the method comprising:
modeling an operations dictionary by identifying a first set of discriminative words from business facts data of an enterprise, the first set of discriminative words indicative of a plurality of concepts in the business facts data;
modeling a regulations dictionary by identifying a second set of discriminative words from a regulatory rules data, the regulatory rules data associated with compliance rules of the enterprise;
modeling a terminological dictionary comprising terminological variations of the plurality of concepts and natural language statements associated with the regulatory rules data;
obtaining a proof of one of a compliance and non-compliance in form of one of success rules and failure rules and corresponding facts from a compliance determination engine; and
systematically mapping words selected from the operations dictionary, the regulations dictionary and the terminological dictionary based at least on a concept of the plurality of concepts in the proof to obtain the explanation of the proof in natural language.
